(19) United States
(12) Patent Application Publication
(10) Pub. No.: US 2012/0147626 A1
(43) Pub. Date: Jun. 14, 2012

(54) BACKLIGHT MODULE

(75) Inventor: Ta-Jen Huang, Hsin-Chu (TW)

(73) Assignee: AU OPTRONICS CORP., HSINCHU (TW)

(21) Appl. No.: 13/114,553

(22) Filed: May 24, 2011

(30) Foreign Application Priority Data
Dec. 8, 2010 (TW) 099142881

(51) Int. Cl. F21V 7/22

(52) U.S. Cl. 362/612; 362/611

(57) ABSTRACT

The backlight module includes a holder having a holder sidewall, a light source disposed on the holder, a light guide plate, and a frame. An end of the light guide plated is fixed on the holder. The frame has a frame sidewall. The holder is assembled on the frame, wherein a gap is formed between the holder sidewall and the frame sidewall, and the gap is utilized as a buffer space of the deformation of the light guide plate.

### RELATED APPLICATIONS

This application claims priority to Taiwan Application Serial Number 099142881, filed Dec. 8, 2010, which is herein incorporated by reference.

### BACKGROUND

1. Field of Invention

The present invention relates to a display. More particularly, the present invention relates to a backlight module of a display.

2. Description of Related Art

Recently, liquid crystal displays (LCD) have been widely applied in electrical products, due to the rapid progress of optical technology and semiconductor technology. Moreover, with the advantages of high image quality, compact size, light weight, low driving voltage, and low power consumption, LCDs have been introduced into portable computers, personal digital assistants, color televisions, and are gradually replacing the cathode ray tubes (CRT) used in conventional displays. LCDs have become the mainstream display apparatus.

The LCD mainly includes a liquid crystal display panel, a backlight module, and a bracket. The backlight module provides the light source, which includes a light bar, a light guide plate, and a frame. The liquid crystal display panel is stuck on the frame of the backlight module with a double side adhesive tape, and then the liquid crystal display panel and the backlight module are assembled in the bracket.

The light guide plate must be well positioned for providing uniform light emitting efficiency. The light guide plate is made of polymethylmethacrylate (PMMA), which is very sensitive to temperature and moisture. For example, a deformation of a 15″ light guide plate along the length direction under different temperature and moisture can reach to 0.5 mm. The light guide plate may be expanded or contracted in different environment. The expansion of the light guide plate would lead to bending of the light guide plate and make the light emitting surface uneven. The contraction of the light guide plate would change the relative position between the light guide plate and the light source, so that a problem of light leakage would be raised.

Therefore, there is a need to reduce problems due to the deformation of the light guide plate under different environments.

### SUMMARY

An embodiment of the invention provides a backlight module. The backlight module includes a holder having a holder sidewall, a light source disposed on the holder, a light guide plate, and a frame. An end of the light guide plated is fixed on the holder. The frame has a frame sidewall. The holder is assembled on the frame, wherein a gap is formed between the holder sidewall and the frame sidewall, and the gap is utilized as a buffer space of the deformation of the light guide plate. The light guide plate includes plural protrusions, and the holder includes plural openings coupling to the protrusions respectively. The light source includes plural light emitting diodes, and the light sources and the openings are stagger arranged. The backlight module further includes a printed circuit board disposed between the light source and the holder, and the printed circuit board includes plural holes corresponding to the openings. The light source is in contact with the light guide plate. The frame is a cover or a bezel. An opposite end of the light guide plate is fixed on the frame. A ratio of a width of the gap to a width between the end and the opposite end of the light guide plate is from 0.23% to 0.29%. The frame clamps the holder.

The light guide plate is fixed on the holder, and the holder can be slid relative to the frame. The gap between the holder and the frame is utilized as the buffer space of the deformation of the light guide plate. Therefore, the surface of the light guide plate can be kept flat when the light guide plate is expanded or contracted due to the change of environment. The light source and the light guide plate are both fixed on the holder. The relative position of the light source and the light guide plate is fixed, so that the light leakage can be prevented when the light guide plate is expanded or contracted.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a partial schematic diagram of a first embodiment of the backlight module of the invention;

FIG. 2 is a sectional diagram of the first embodiment of the backlight module of the invention;

FIG. 3 is an assembly schematic diagram of the light guide plate and the holder of the first embodiment of the backlight module of the invention;

FIG. 4 is an assembly schematic diagram of the light guide plate and the holder from another view of the first embodiment of the backlight module of the invention; and

FIG. 5 is a sectional diagram of a second embodiment of the backlight module of the invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

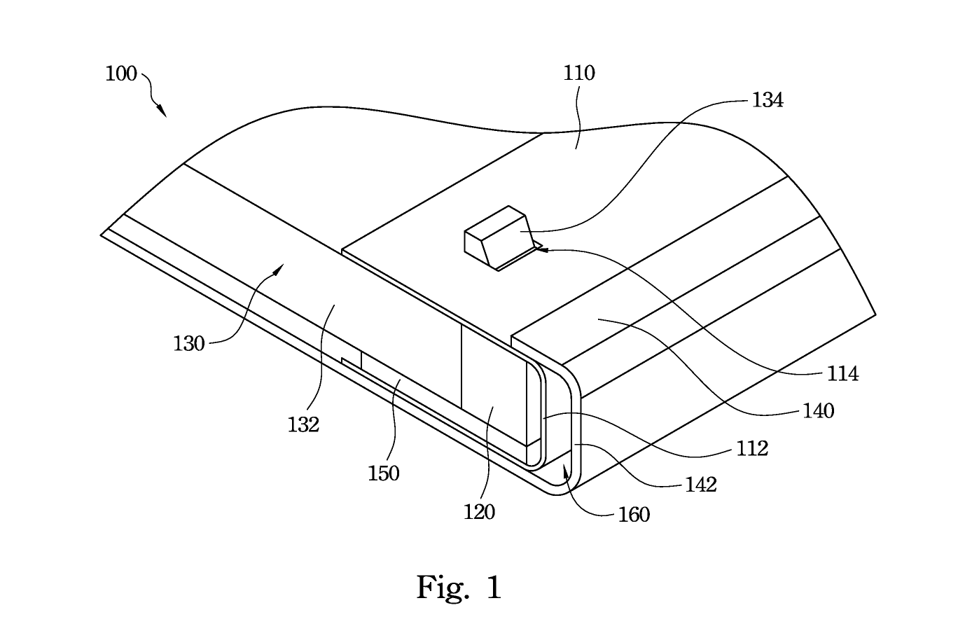

FIG. 1 is a partial schematic diagram of a first embodiment of the backlight module of the invention. The backlight module 100 includes a holder 110, a light source 120, a light guide plate 130, a frame 140, and a printed circuit board 150. The light source 120 is disposed on the holder 110. More particularly, the holder 110 is a ⊃-shaped structure, and the holder 110 has a holder sidewall 112 formed opposite to the inlet of the ⊃-shaped structure. The light source 120 is disposed in the space of the ⊃-shaped structure. An end 132 of the light guide plate 130 is fixed on the holder 110. The end 132 of the light guide plate 130 inserts into the ⊃-shaped structure holder 110 through the inlet and is in contact with the light source 120. The printed circuit board 150 is disposed between the light source 120 and the holder 110. The light guide plate 130, the light source 120, and the printed circuit board 150 are assembled to the holder 120, and the holder 110 is assembled to the frame 140. A side of the frame 140 is a ⊃-shaped structure, and the frame 140 has a frame sidewall 142. The holder 110 is assembled within the frame sidewall 142, and a gap 160 is formed between the holder sidewall 112 and the frame sidewall 142. The holder 110 can be slid relative to the frame 140, and the gap 160 is utilized as a buffer of the deformation of the light guide plate 130.

The light guide plate 130 has plural protrusions 134. The holder 110 has plural protrusions 114. The protrusions 134 of the light guide plate 130 couple to the openings 114 of the holder 110 to fix the end 132 of the light guide plate 130 on the holder 110 when the light guide plate 130 is assembled to the holder 110.

The frame 140 can be a cover or a bezel of an LCD display. The frame 140 can be made of metal. The frame 140 has a C-shaped clamping structure. The frame 140 clamps the holder 110 so that the holder 110 is positioned in the frame 140. The holder 110 is positioned in the frame 140 only with the elastic clamping force provided by the frame 140. Therefore the holder 110 and the light guide plate 130 therein can be slid relative to the frame 140 when the light guide plate 130 is expanded or contracted. The gap 160 is utilized as the buffer space for sliding the holder 110 relative to the frame 140 when there is a deformation of the light guide plate 130. The light guide plate 130 can expand along the space of the gap 160, so that the situation of deflection of the light guide plate 130 can be prevented, and the surface of the light guide plate 130 can be maintained flat.

The light source 120 is fixed on the holder, and the light guide plate 130 is also fixed on the holder 110, therefore the relative position of the light guide plate 130 and the light source 120 is still fixed when the light guide plate 130 is expanded or contracted, so that the problem of light leakage can be prevented.

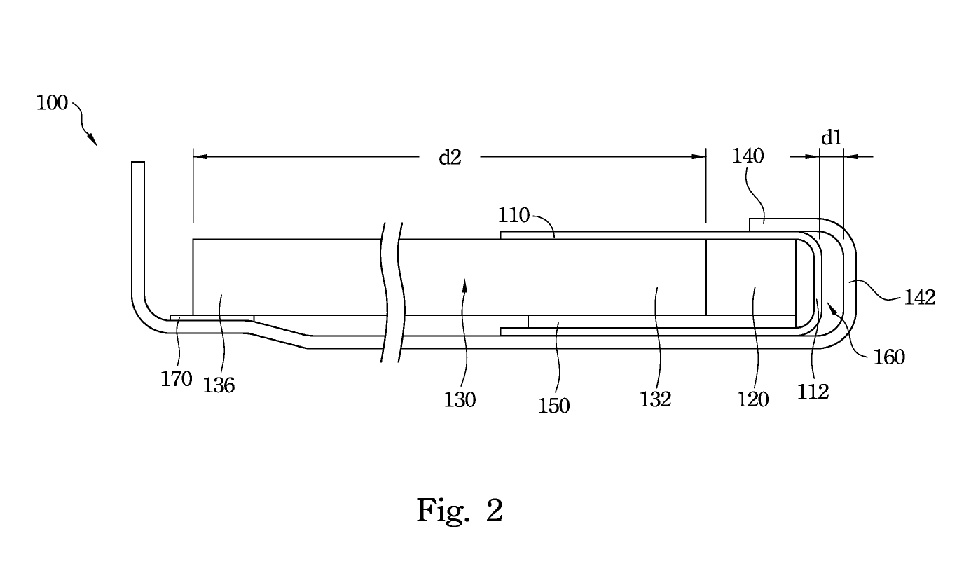

FIG. 2 is a sectional diagram of the first embodiment of the backlight module of the invention. The backlight module 100 has the holder 110, the light source 120, the light guide plate 130, the frame 140, and the printed circuit board 150. The light source 120 is disposed on the holder 110. The end 132 of the light guide plate 130 is fixed on the holder 110. The holder 110 is assembled to the frame 140. The printed circuit board 150 is disposed between the light source 120 and the holder 110. The holder 110 has a holder sidewall 112, and the frame 140 has the frame sidewall 142. The holder 110 is assembled within the frame sidewall 142. There is the gap 160 formed between the holder sidewall 112 and the frame sidewall 142. The holder 110 can be slid relative to the frame 140, and the gap 160 is utilized as a buffer space of the deformation of the light guide plate 130.

The light emitting surface of the light source 120 is in contact with the end 132 of the light guide plate 130 firmly. An opposite end 136 of the light guide plate 130 can be fixed on the frame 140 with an adhesive device 170.

A ratio of a width dl of the gap 160 to a width d2 between the end 132 and the opposite end 136 of the light guide plate 130 is preferably from 0.23% to 0.29%.

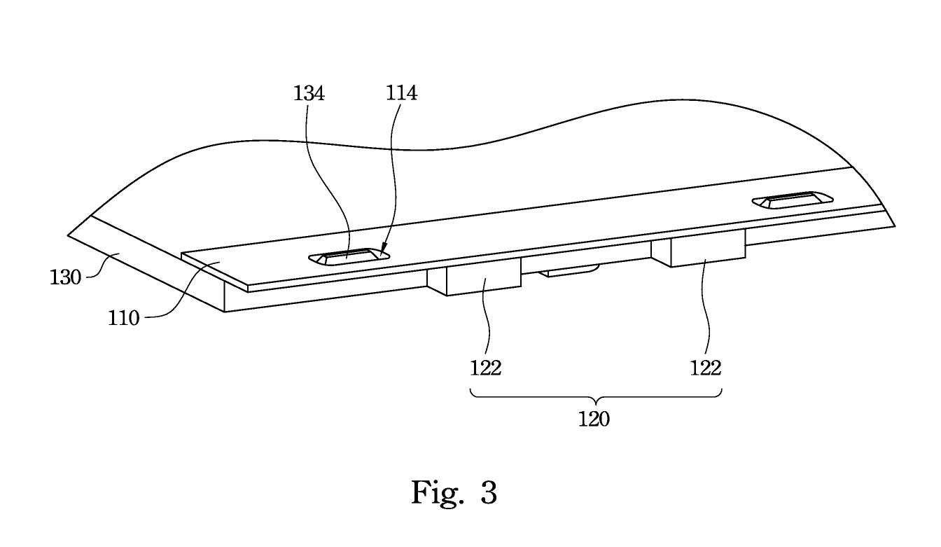

FIG. 3 is an assembly schematic diagram of the light guide plate and the holder of the first embodiment of the backlight module of the invention. A part of the holder 110 is hidden in this diagram for better describing. The light source 120 includes plural light emitting diodes 122. The openings 114 of the holder 110 and the light emitting diodes 122 are stagger arranged. The light emitting diodes 122 are arranged between the openings 114 and do not overlap to the openings 114. Therefore the problem of light leakage between the light emitting diodes 122 and the openings 114 can be reduced. The protrusions 134 of the light guide plate 130 are arranged corresponding to the openings 114 and are stagger arranged to the light emitting diodes 122. The protrusions 134 can be disposed on two opposite sides of the light guide plate 130.

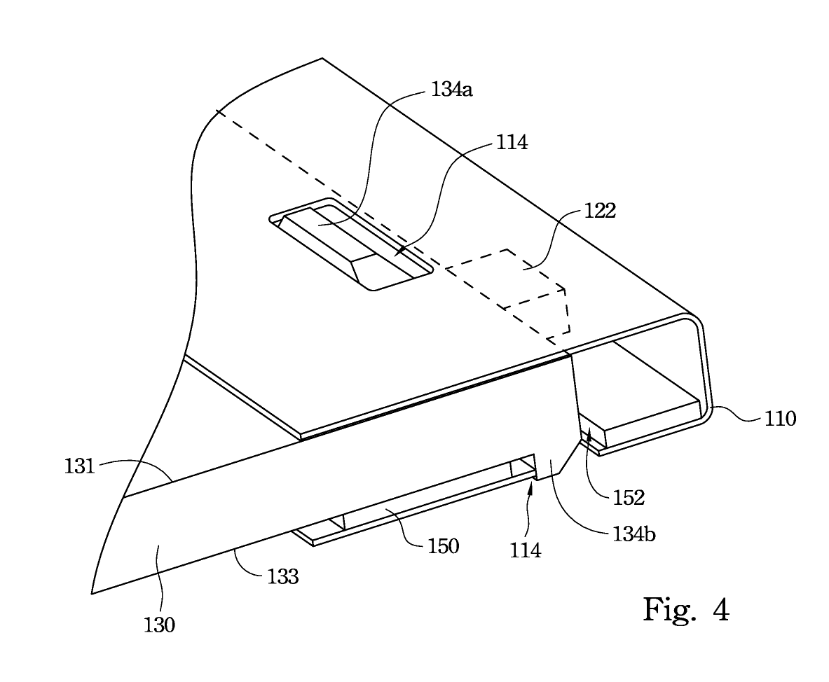

FIG. 4 is an assembly schematic diagram of the light guide plate and the holder from another view of the first embodiment of the backlight module of the invention. The protrusions 134a, 134b are disposed on the top surface 131 and the bottom surface 133 of the light guide plate 130. The protrusions 134a, 134b are stagger arranged to the light emitting diodes 122. The printed circuit board 150 is disposed between the holder 110 and the light guide plate 130. The printed circuit board 150 has plural holes 152 disposed corresponding to the protrusions 134b disposed on the bottom surface 133 of the light guide plate 130. The protrusions 134b disposed on the bottom surface 133 of the light guide plate 130 pass through the holes 152 and couple to the openings 114 of the holder 110.

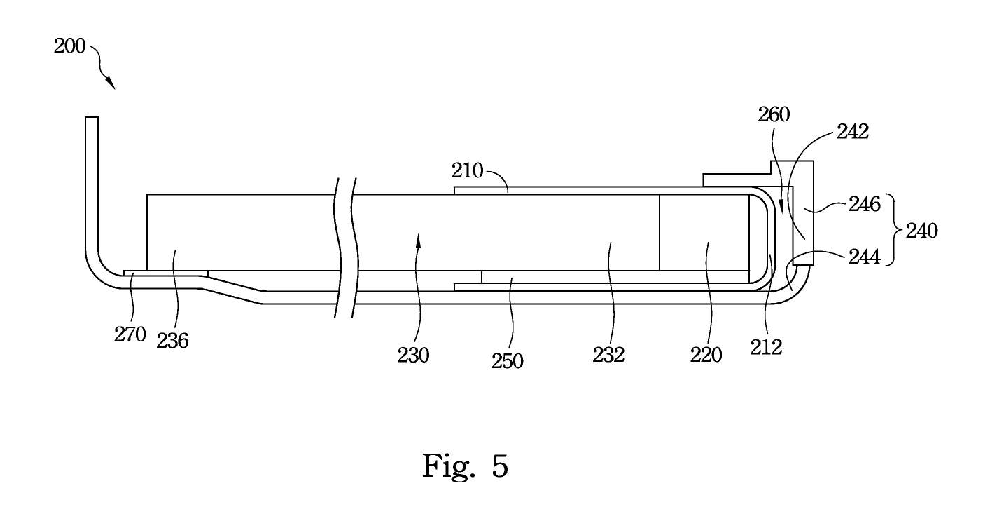

FIG. 5 is a sectional diagram of a second embodiment of the backlight module of the invention. The backlight module 200 includes the holder 210, the light source 220, the light guide plate 230, the frame 240, and the printed circuit board 250. The light source 220 is disposed on the holder 210. An end 232 of the light guide plate 230 is fixed on the holder 210, and another end 236 of the light guide plate 230 is fixed on the frame 240 with the adhesive device 270. The holder 210 is assembled to the frame 240. The printed circuit board 250 is disposed between the light source 220 and the holder 210. The holder 210 has the holder sidewall 212. The frame 240 has the frame sidewall 242. The gap 260 is formed between the holder sidewall 212 and the frame sidewall 242. The frame 240 clamps the holder 210, and the holder 210 can be slid relative to the frame 240. The gap 260 is utilized as the buffer space of the deformation of the light guide plate 230. The frame 240 is a display bezel or a display cover. The frame 240 can include a metal piece 244 and a plastic frame 246 thereon. The assembly of the light guide plate 230 and the holder 210 is shown as FIG. 3 and FIG. 4.

According to above embodiments, the present invention has the following advantages. The light guide plate is fixed on the holder, and the holder can be slid relative to the frame. The gap between the holder and the frame is utilized as the buffer space of the deformation of the light guide plate. Therefore, the surface of the light guide plate can be kept flat when the light guide plate is expanded or contracted due to the change of environment. The light source and the light guide plate are both fixed on the holder. The relative position of the light source and the light guide plate is fixed, so that the light leakage can be prevented when the light guide plate is expanded or contracted.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their to equivalents.

What is claimed is:

1. A backlight module comprising:
a holder having a holder sidewall;
a light source disposed on the holder;
a light guide plate, an end of the light guide plated fixed on the holder; and
a frame having a frame sidewall, the holder assembled on the frame, wherein a gap is formed between the holder sidewall and the frame sidewall, and the gap is utilized as a buffer space of the deformation of the light guide plate.

2. The backlight module of claim 1, wherein the light guide plate comprises a plurality of protrusions, and the holder comprises a plurality of openings coupling to the protrusions respectively.

3. The backlight module of claim 2, wherein the light source comprises a plurality of light emitting diodes, and the light sources and the openings are stagger arranged.

4. The backlight module of claim 2, further comprising a printed circuit board disposed between the light source and the holder, and the printed circuit board comprises a plurality of holes corresponding to the openings.

5. The backlight module of claim 1, wherein the light source is in contact with the light guide plate.

6. The backlight module of claim 1, wherein the frame is a cover or a bezel.

7. The backlight module of claim 1, wherein an opposite end of the light guide plate is fixed on the frame.

8. The backlight module of claim 1, wherein a ratio of a width of the gap to a width between the end and the opposite end of the light guide plate is from 0.23% to 0.29%.

9. The backlight module of claim 1, wherein the frame clamps the holder.
